(19) United States
(12) Patent Application Publication
(10) Pub. No.: US 2017/0148059 A1
(43) Pub. Date: May 25, 2017

(54) System for Promoting Spontaneous Purchases of Goods Using Prestocked Lockers and Proximity Marketing

(71) Applicants: David D. Minter, Littleton, CO (US); Albert S. Baldocchi, Boulder, CO (US); Jeffrey D. Minter, Littleton, CO (US)

(72) Inventors: David D. Minter, Littleton, CO (US); Albert S. Baldocchi, Boulder, CO (US); Jeffrey D. Minter, Littleton, CO (US)

(21) Appl. No.: 15/425,565

(22) Filed: Feb. 6, 2017

Related U.S. Application Data
(63) Continuation of application No. 13/769,084, filed on Feb. 15, 2013.

(51) Int. Cl. G06Q 30/02; G07C 9/00; G06Q 30/06

(52) U.S. Cl. CPC G06Q 30/0259; G06Q 30/0269; G06Q 30/0255; G06Q 30/0633; G06Q 30/0267; G06Q 30/0265; G07C 9/00126; G07C 9/00309

(57) ABSTRACT

System for promoting spontaneous purchases of goods using prestocked lockers and proximity marketing. Locker banks having secure lockers are deployed at strategic locations near consumers. The lockers are prestocked with items available for purchase. The prestocked items are marketed to roaming consumers whose mobile devices report Global Positioning System (GPS) positions near the locker banks. When purchase commitments respecting prestocked items are received from consumers via their mobile devices, access keys to lockers where the purchased items are stocked are activated and the consumers retrieve the purchased items from the lockers using the access keys.

### CROSS-REFERENCE TO RELATED APPLICATION

This application is a continuation of prior U.S. application Ser. No. 13/769,084 entitled “METHODS AND SYSTEMS FOR FACILITATING COMMERCIAL DISTRIBUTION OF MERCHANDISE FROM PRESTOCKED LOCKERS,” filed on Feb. 15, 2013, and incorporated herein by reference.

### BACKGROUND OF THE INVENTION

The present invention relates to commercial distribution and, more particularly, commercial distribution of merchandise from lockers.

Traditionally, consumers have shopped in “bricks and mortar” retail stores filled with large quantities of merchandise and large numbers of retail clerks. These traditional stores have some advantages. One advantage is immediate order fulfillment. That is, consumers can walk into the store, buy the items they want and leave the store with goods in hand. However, these traditional stores have significant disadvantages in terms of high operating costs (e.g., real estate, electricity, inventory, labor, security, etc.) and are burdened by the requirement to collect sales tax. This generally means higher prices for consumers. Moreover, these traditional stores tend to keep regular business hours that are inconvenient for many consumers.

Online shopping has represented a paradigm shift in the way consumers buy merchandise. Unlike their “bricks and mortar” counterparts, online stores browsed by consumers on the Internet typically have very low operating costs and have been mostly immune from the requirement to collect sales tax, generally resulting in lower prices for consumers. Moreover, online stores often operate 24/7 which provides added consumer convenience. On the other hand, order fulfillment has posed a big problem in online shopping. Consumers cannot leave an online store with goods in hand. Instead, merchandise purchased from an online store must be transported to the consumer's home or workplace from a warehouse where the goods are stored, or directly from the manufacturer, by a carrier such as the U.S. Postal Service, Federal Express or United Parcel Service. This transport of goods takes time and costs money and goods can be lost or damaged in transit. Additionally, the consumer might not be present when the merchandise finally arrives at his or her doorstep, raising security concerns if the carrier leaves the goods unattended.

More recently, some online retailers (e.g., Amazon) have installed locker banks at various locations where consumers can designate that merchandise purchased from their web stores be delivered. Allowing online consumers to specify a nearby locker bank as a drop point for their purchased items allays security concerns associated with leaving merchandise in unsecured locations. However, these locker banks do not solve a fundamental problem of Internet order fulfillment: The goods must still be transported to a designated delivery point from a remote location at risk of loss or damage and the customer must wait for them be delivered.

### SUMMARY OF THE INVENTION

The present invention provides methods and systems for facilitating commercial distribution of merchandise from prestocked lockers. A locker bank having multiple secure lockers is deployed at a strategic location near consumers. The locker bank is prestocked with goods available for purchase. Goods are selected for prestocking using local consumer preference data. The prestocked goods are marketed to local consumers in a marketing campaign. When a purchase commitment respecting one of the prestocked goods is received from a local consumer, an access key to a locker in the locker bank where the purchased good is stocked is provided to the local consumer and the local consumer can retrieve the purchased good from the locker using the access key. Through the foregoing arrangement, merchandise is distributed to local consumers in a convenient, inexpensive, secure, targeted and timely manner. On the convenience front, local consumers can both purchase and pick-up the prestocked goods 24/7. On the cost front, real estate, electricity, inventory, labor, security and other costs associated with traditional retail distribution of goods are saved. On the security front, goods are stored securely until retrieved by the local consumers who purchased them. On the targeting front, selecting goods for prestocking using local consumer preference data makes it highly likely that the prestocked goods will satisfy local consumer demand and will sell quickly. On the timeliness front, local consumers can pick-up goods immediately after purchase by traveling to the nearby locker bank where the goods are stocked.

In one aspect of the invention, a system for facilitating commercial distribution of merchandise from prestocked lockers comprises a locker; and a system management processor operatively coupled with the locker and configured to detect that the locker is vacant, select using consumer preference data local to the locker a first good for prestocking in the locker and place a prestocking order indicating to prestock the first good in the locker.

In some embodiments, the processor is further configured to receive a prestocked locker notification indicating that the first good is prestocked in the locker.

In some embodiments, the processor is further configured to generate an access key for the locker, receive from a consumer a purchase commitment for the first good and provide to the consumer the access key.

In some embodiments, the processor is further configured to receive from a consumer a purchase commitment for the first good, receive from the consumer an access key, verify the access key and unlock the locker.

In some embodiments, the processor is further configured to receive from a consumer a purchase inquiry for the first good, determine that the first good is no longer available for purchase from the locker and notify the consumer of a nearest locker where a second good like the first good is available for purchase.

In some embodiments, the processor is further configured to receive from a consumer a purchase inquiry for the first good, determine a second good available for purchase from a locker sharing a locker bank with the locker where the first good is prestocked, and notify the consumer that the second good is available for purchase from the locker bank.

In some embodiments, the processor is further configured to receive from a consumer a purchase inquiry for the first good and a second good, determine that the second good is not available for purchase from a locker bank where the first good is prestocked, notify the consumer of a joint pickup time for the first good and the second good from the locker bank and place a prestocking order indicating to prestock the second good at the locker bank prior to the joint pickup time.

In some embodiments, the locker is configured in a locker bank having a plurality of lockers, and the processor is further configured to determine an actual inventory in the locker bank, determine using the local consumer preference data a target inventory for the locker bank, determine differences between the actual inventory and the target inventory and select as the first good a good from a global inventory that reduces the differences.

In some embodiments, the local consumer preference data comprise local consumer demographic data.

In some embodiments, the local consumer preference data comprise local consumer past purchase data.

In some embodiments, the local consumer preference data comprise local consumer wish list data.

In some embodiments, the processor is further configured to market the first good to consumers local to the locker in a marketing campaign.

In some embodiments, the marketing campaign comprises a short-range marketing campaign.

In some embodiments, the short-range marketing campaign comprises a global positioning system (GPS)-driven Internet push advertisement.

In some embodiments, the short-range marketing campaign comprises a short-range network advertisement.

In some embodiments, the short-range marketing campaign comprises a point of fulfillment advertisement.

In some embodiments, the marketing campaign comprises a general marketing campaign.

In some embodiments, the general marketing campaign comprises a non-GPS-driven Internet push advertisement.

In some embodiments, the general marketing campaign comprises a wish list fulfillment notification.

In another aspect of the invention, a related method for facilitating commercial distribution of merchandise from prestocked lockers comprises detecting by a system management processor a locker that is vacant; selecting by the processor using consumer preference data local to the locker a first good for prestocking in the locker; and placing by the processor a prestocking order indicating to prestock the first good in the locker.

These and other aspects of the invention will be better understood by reference to the detailed description of a preferred embodiment taken in conjunction with the drawings briefly described below. Of course, the scope of the invention is defined by the appended claims.

### BRIEF DESCRIPTION OF THE DRAWINGS

FIG. 1 shows a system for facilitating commercial distribution of merchandise from prestocked lockers.

FIG. 2 shows a locker bank.

FIG. 3 shows a method for prestocking a vacant locker in a locker bank.

FIG. 4 shows elements used in determining a target inventory for a locker bank.

FIG. 5 shows a first method for facilitating commercial distribution of merchandise from a prestocked locker.

FIG. 6 shows a second method for facilitating commercial distribution of merchandise from a prestocked locker.

FIG. 7 shows elements of a marketing campaign for merchandise in a prestocked locker.

### DETAILED DESCRIPTION OF A PREFERRED EMBODIMENT

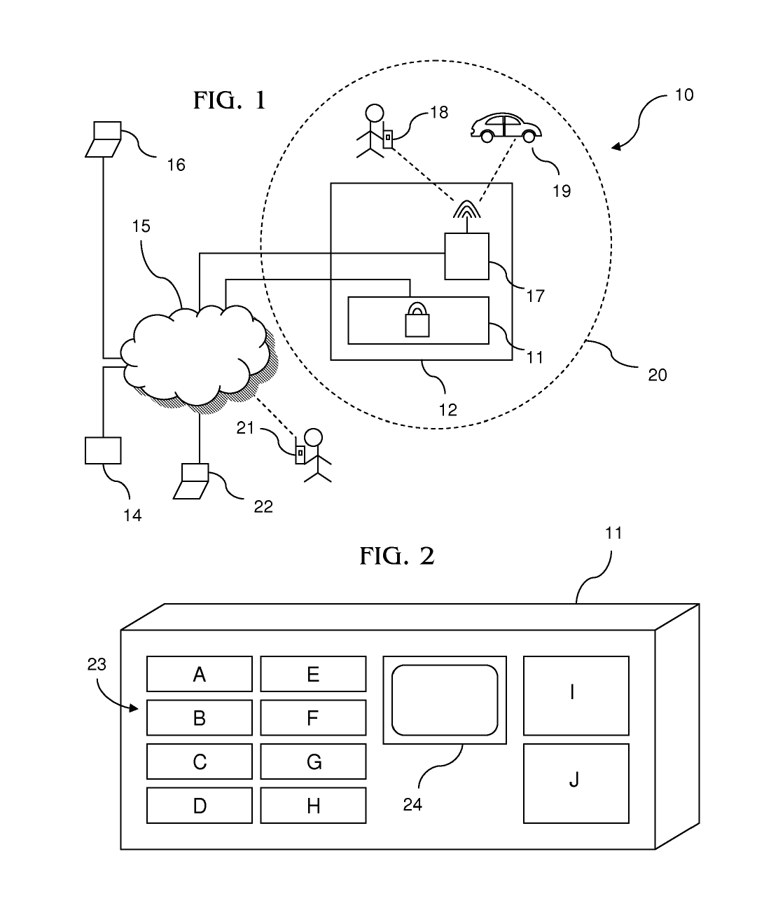

FIG. 1 shows a system 10 for facilitating commercial distribution of merchandise from prestocked lockers. System 10 distributes prestocked goods in a convenient, inexpensive, secure, targeted and timely manner to local consumers who communicate with system 10 via networked computing devices, such as smartphones, tablet computers, notebook computers and desktop computers. Prestocked goods are stocked in lockers and made available for purchase by local consumers once securely stocked. Prestocked goods are, generally speaking, non-perishable wares such as clothing items, collectibles, consumer electronics, educational and entertainment media (e.g., books, CDs, DVDs, video game cartridges, etc.), gardening items, household items, outdoor and recreational items, toys and jewelry. However, prestocked goods may also include perishable items and lockers in which perishable items are prestocked may be climate controlled (i.e., heated or refrigerated) to extend the shelf life of such items.

System 10 includes a locker bank 11 deployed at a locker bank site 12. Locker bank site 12 may be a building dedicated to locker bank 11 or a building that locker bank 11 shares with one or more other commercial enterprises. Depending on implementation, locker bank 11 may provide walk-up access, drive-through access, or both. Locker bank 11 has multiple lockers in which goods are securely prestocked and made available for purchase by consumers. Locker bank 11 is communicatively coupled over the Internet 15 with a system management processor 14. System management processor 14 globally manages stocking, marketing, sale and distribution of the prestocked goods from multiple locker banks within system 10, including locker bank 11. System management processor 14 is communicatively coupled over the Internet 15 with an order display device 16 at a global inventory dispatch site that receives and displays prestocking orders transmitted by system management processor 14.

System management processor 14 is a networked computing device, such as a server, workstation, or personal computer having processing and memory resources. System management processor 14 may perform processing and data storage and retrieval functions attributed to processor 14 herein in software or a combination of software and custom circuitry. In some embodiments, functions of system management processor 14 are distributed across multiple devices.

System 10 may be operated by a single commercial entity or jointly operated by multiple commercial entities. For example, a commercial entity that operates locker bank site 12 may lease locker bank 11 for a term to another commercial entity that operates system management processor 14. In another example, a commercial entity that operates locker bank site 12 may lease selected lockers within locker bank 11 for a term to a first commercial entity that operates system management processor 14 and lease other lockers within locker bank 11 during the same term to a second commercial entity. In yet another example, a commercial entity that operates locker bank site 12 may dynamically lease individual lockers within locker bank 11 to other commercial entities on demand.

System 10 has particular advantages for roaming consumers who are presently within a short range 20 of locker bank site 12 and can be reached by a short-range marketing campaign. The breadth of short range 20 may be configured or may be inherent in the technologies involved. For example, a short-range network advertisement (e.g., Wi-Fi ad) selected by system management processor 14 may be broadcast via a wireless access point 17 deployed at locker bank site 12 to a pedestrian carrying a smartphone 18 and a commuter riding in a car 19 within the broadcast range of access point 17. The short-range network advertisement may advertise a prestocked good in locker bank 11, such as: “Item X available for pickup right now at Broadway and Elm for only $Y.YY!” In another example, a GPS-driven Internet push advertisement having similar content may be delivered via a cell tower to smartphone 18 and car 19 based on their recently reported GPS positions within short range 20 of locker bank site 12. Such short-range advertising is designed to incent consumers roaming near locker bank site 12 to spontaneously purchase and pick-up merchandise of interest from locker bank 11, rather than making a traditional online purchase or weekend trip to a shopping mall.

System 10 also has advantages for consumers who are not presently within short range 20 of locker bank site 12 but who can conveniently get there. For example, system management processor 14 may transmit a non-GPS-driven Internet push advertisement for a prestocked good in locker bank 11 to a pedestrian carrying a smartphone 21 and a worker using a desktop computer 22 who are remote from locker bank site 12 at present but who, based on their history of past purchases at or near locker bank site 12, may be interested in purchasing the prestocked item and traveling to locker bank site 12 to pick it up.

FIG. 2 shows locker bank 11 in more detail. Locker bank 11 includes a plurality of lockers 23 and a touch screen display 24. Lockers 23 have different sizes and different identifiers (A through J) that allow lockers 23 to be unambiguously identified by system 10 and consumers alike. When locked, lockers 23 prevent access to and viewing of goods stored inside of lockers 23. Alternatively, some or all goods inside of lockers 23 may be viewable, such as through transparent viewing windows made of a tamper-resistant material (e.g., PLEXIGLAS®) built into locker doors. Locker bank 11 is communicatively coupled with system management processor 14 via the Internet. Lockers 23 are unlocked in response to unlock commands issued by system management processor 14 after verifying access keys entered on touch screen display 24 by consumers who purchased the items stored in lockers 23. For example, touch screen display 24 may be initially display a page that prompts a consumer for an access key, such as a ten digit code. Upon entry by the consumer of an access key and verification of the access key by system management processor 14, the one of lockers 23 associated with the verified access key may be unlocked and touch screen display 24 may display an informational page instructing the consumer (e.g., by displaying the locker identifier of the unlocked locker) which one of lockers 23 has been unlocked. In some embodiments, consumers can also use voice commands to interact with locker bank 12 and touch screen display 24.

In some embodiments, access to lockers may be controlled by additional or different types of access keys, such as credit card information inputted or swiped at locker bank site 12 or verifiable biometric information collected at locker bank site 12 (e.g., fingerprint scan, retinal scan, voice scan, etc.).

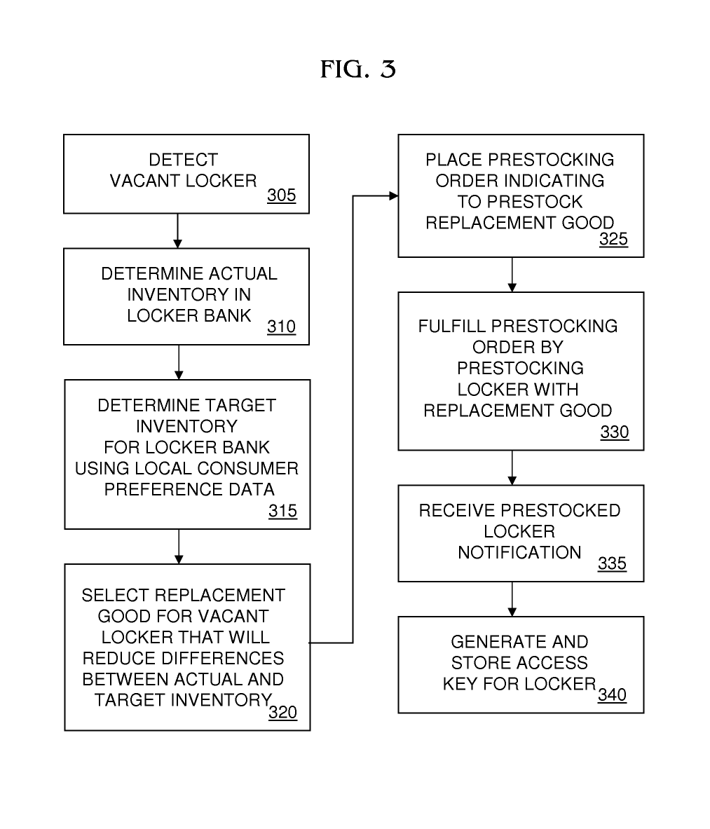

FIG. 3 shows a method for prestocking a vacant locker in locker bank 11. At the outset, system management processor 14 detects that one of lockers 23 in locker bank 11 is vacant (305). The vacancy may be detected, for example, when system management processor 14 verifies an access key entered on touch screen display 24 and issues an unlock command to locker bank 11.

Next, system management processor 14 determines the actual inventory in locker bank 11 (310). System management processor 14 maintains data records of the actual inventories at all locker banks within system 10, including locker bank 11. Actual inventory data records for locker banks include data on overall inventories at locker banks as well as breakdowns of sold versus unsold inventories at locker banks. In response to detecting that one of lockers 23 in locker bank 11 is vacant, system management processor 14 updates the actual inventory data record for locker bank 11 by marking the locker as vacant.

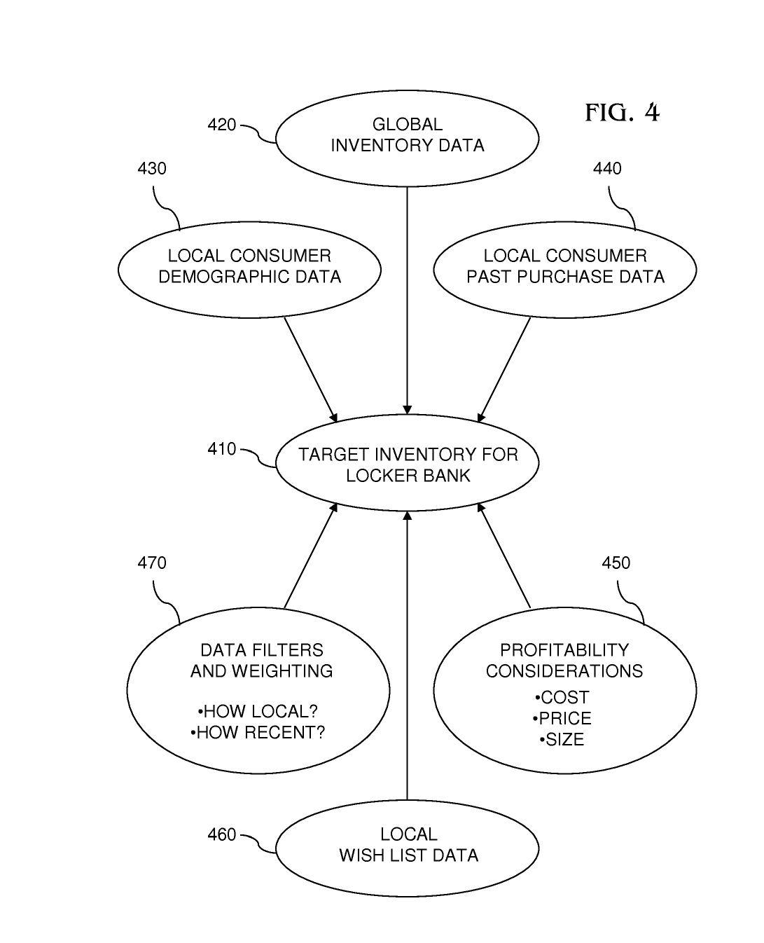

Next, system management processor 14 determines a target inventory for locker bank 11 using local consumer preference data (315), as well as other data. System management processor 14 determines target inventories for all locker banks within system 10, including locker bank 11. A target inventory is a programmatically determined ideal (e.g., profit-maximizing) inventory for a given locker bank under present market conditions. FIG. 4 shows exemplary inputs used in determining a target inventory 410 for locker bank 11. Global inventory data 420 defines the universe of goods available within system 10 that might be selected as a replacement good to restock the vacant locker. Local consumer demographic data 430 provides demographic information (e.g., age, gender, economic well-being, etc.) about the population in the vicinity of locker bank 11 (e.g., within zip code, certain distance, etc.) that may provide clues as to which prestocked goods are most likely to satisfy local consumer demand. An example of such demographic information is PRIZM® consumer groupings. Local consumer past purchase data 440 provides information about past purchases made by consumers at or near locker bank 11 that may provide further clues as to which prestocked goods are most likely to meet local consumer demand. Profitability considerations 450 provide information that bears on the profitability of prestocked goods apart from local consumer preference data, such as cost, price and size. Local wish list data 460 provides information about prestocking requests for particular goods made by consumers in the vicinity of locker bank 11. Data filters and weighting 470 filter and weight the above input data based on how local the data are to locker bank site 12 and how recent the data are. For example, demographic and past purchase data respecting consumers who live within a one mile radius of locker bank site 12 may be given full weight whereas such data respecting consumers who live outside the one mile radius may be excluded or given lesser weight in determining the target inventory for locker bank 11. Similarly, past demographic and past purchase data respecting consumers that is less than six months old may be given full weight whereas such data that is more than six months old may be excluded or given lesser weight in determining the target inventory for locker bank 11.

Next, system management processor 14 selects a replacement good for the vacant locker that will improve correspondence between the actual inventory in locker bank 11 and the target inventory for locker bank 11 (320). System management processor 14 compares the actual inventory data record for locker bank 11 with the programmatically determined target inventory for locker bank 11 and identifies points of difference and the extent of differences. Differences between the actual and target inventories may be analyzed relative to various factors, such as classes of goods (e.g., clothes v. books), subclasses of goods (e.g., shirts v. shoes) and quantities of goods (e.g., 5 v. 1). System management processor 14 selects a replacement good for the vacant locker that will reduce these differences.

Next, system management processor 14 places a prestocking order indicating to prestock the replacement good in the vacant locker (325). The prestocking order includes a locker bank identifier that unambiguously identifies locker bank 11 and a vacant locker identifier that, when combined with the locker bank identifier, unambiguously identifies the vacant one of lockers 23. The prestocking order also unambiguously identifies the replacement good chosen to restock the vacant locker. System management processor 14 generates and transmits the prestocking order to display device 16, which displays the prestocking order.

Next, the prestocking order is fulfilled by prestocking the vacant locker with the replacement good (330). Order fulfillment personnel with access to system 10 review the prestocking order displayed on monitoring device 16, retrieve the replacement good from the global inventory, travel to locker bank site 12, stock the vacant locker with the replacement good and lock the locker. By way of example, the locker may be locked through interaction with touch screen display 24 of an order fulfillment person having an administrative credential. In some embodiments, one or more elements of prestocking order fulfillment may be automated using robotic technology.

In some embodiments, the prestocking order may be displayed on touch screen display 24 at locker bank site 12 in lieu of or in addition to being displayed on display device 16 at a global inventory dispatch site. In these embodiments, order fulfillment personnel may discover or be reminded of which replacement good to prestock in the vacant locker after arriving at locker bank site 12.

Next, system management processor 14 receives a prestocked locker notification (335). The prestocked locker notification may be generated by locker bank 11 in response to detecting that the one of lockers 23 which has been prestocked has been locked through interaction of an order fulfillment person with touch display screen 24 or may be generated by a client device carried by the order fulfillment person. In either event, the prestocked locker notification is transmitted to system management processor 14 over the Internet 15. The prestocked locker notification includes a locker bank identifier that unambiguously identifies locker bank 11 and a prestocked locker identifier that, when combined with the locker bank identifier, unambiguously identifies the prestocked one of lockers 23.

At that point, system management processor 14 generates and stores an access key for the prestocked locker (340). The access key may be stored on system management processor 14 or in an access key database to which system management processor 14 has access.

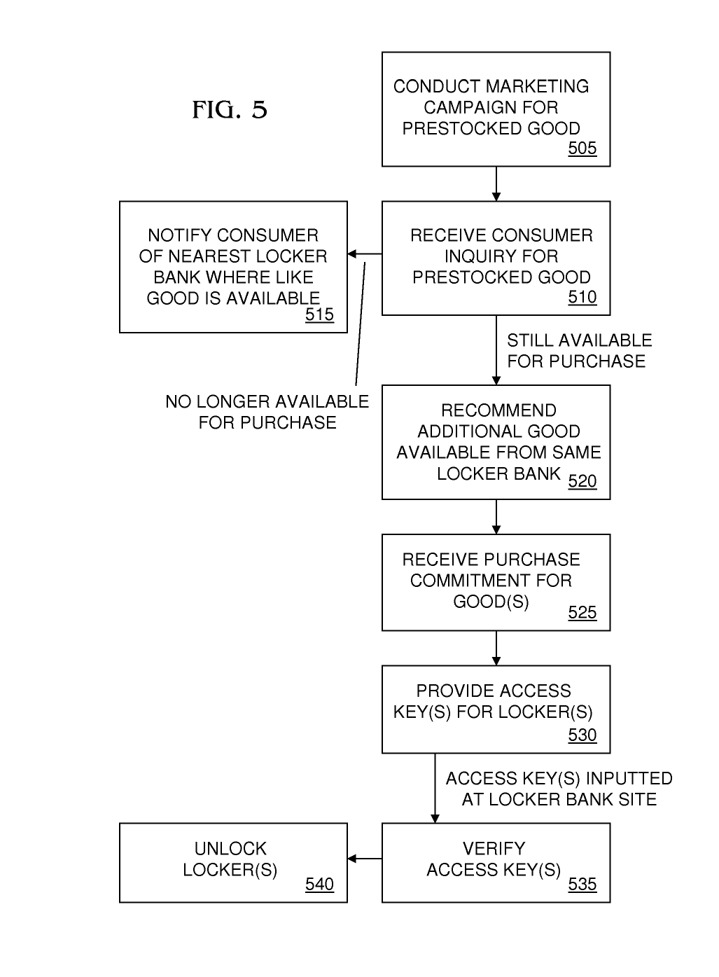

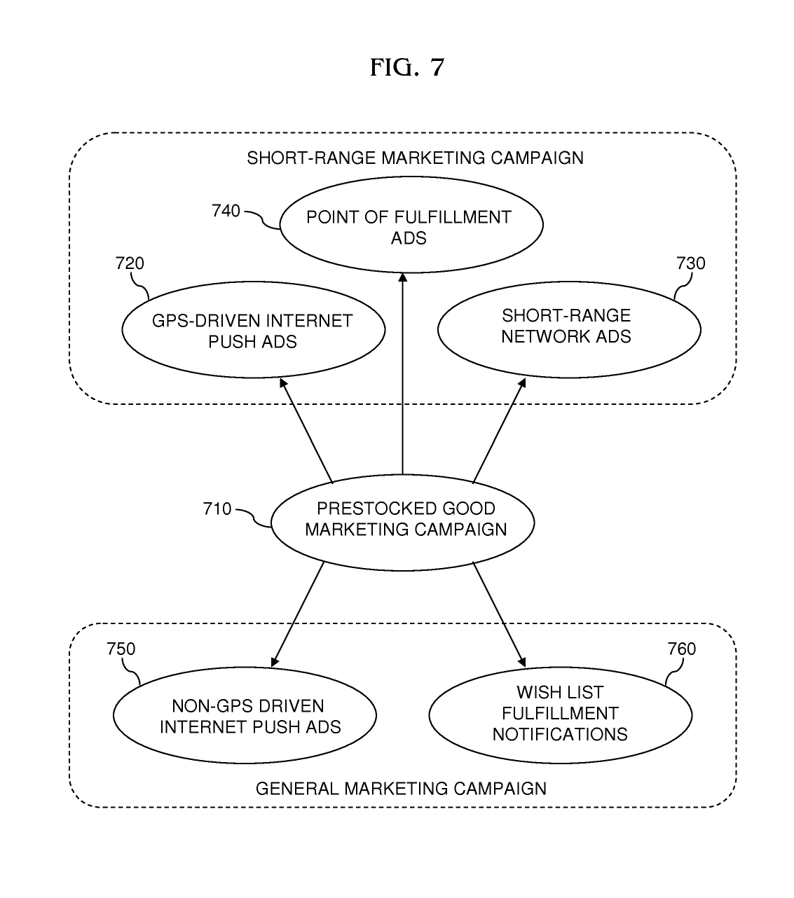

FIG. 5 shows a first method for facilitating commercial distribution of merchandise from a prestocked locker. At the outset, a marketing campaign is conducted to raise awareness among local consumers of the availability for purchase of a prestocked good from one of lockers 23 (505). The marketing campaign may be initiated upon prestocking the good and sustained until the prestocked good is sold. FIG. 7 shows elements of a marketing campaign for a prestocked good. The marketing campaign includes a short-range marketing campaign and a general marketing campaign.

The short-range marketing campaign encourages local consumers who are presently within a certain range of locker bank site 12 to spontaneously purchase the prestocked good and pick it up from locker bank 11. The short-range marketing campaign includes GPS-driven Internet push advertisements 720, short-range network advertisements 730 and point of fulfillment advertisements 740.

GPS-driven Internet push advertisements 720 are ads respecting prestocked goods that are pushed to mobile computing devices which have recently reported a GPS position at or near the locker bank site where the goods are stored. For example, smartphone 18 may have a GPS receiver that tracks the GPS positions of smartphone 18 and client software that reports these GPS positions to system management processor 14 via the Internet 15. System management processor 14 may then compare the reported GPS positions with known locations of locker bank sites and, upon determining that smartphone 18 is within short range 20 of locker bank site 12, may transmit to smartphone 18 via the Internet 15 a push advertisement for a prestocked good in one of lockers 23. The decision whether to send an Internet push advertisement, the good to be advertised and the content of the advertisement (e.g., whether to provide a special discount code) may be influenced by information acquired by system management device 14 about the person who operates smartphone 18, such as demographic, past purchase and wish list information. The decision may also be influenced by merchant interests, such as whether the good is a clearance item that the merchant is interested in selling quickly. Smartphone 18 and car 19 may be configured to admit, decline, or selectively admit based on content Internet push advertisements 720. An Internet push advertisement may take various forms, such as an email alert, text alert or social media alert (e.g., via Facebook, Twitter, etc.).

Short-range network advertisements 730 are ads respecting prestocked goods that are broadcast to mobile computing devices near the locker bank site where the goods are stored. For example, a short-range network advertisement (e.g., Wi-Fi ad) for a prestocked good in one of lockers 23 may be selected by system management processor 14 and broadcast via wireless access point 17. The short-range network ad may be received by computing devices, such as smartphone 18 and car 19 that are operating within a short range 20 of locker bank site 12 (e.g., within the range of the Wi-Fi network). Smartphone 18 and car 19 may be configured to admit, decline, or selectively admit based on content short-range network advertisements 730.

Point of fulfillment advertisements 740 are ads respecting prestocked goods that are outputted from the locker bank site where the goods are stored. For example, locker bank 11 may output an audio advertisement for a prestocked good in one of lockers 23 via a loudspeaker on locker bank 11 that may be heard by consumers who have entered locker bank site 12. As another example, locker bank 11 may output a video advertisement for a prestocked good in one of lockers 23 via a video display at locker bank site 12 (e.g., touch screen display 24) that may be watched by consumers who have entered locker bank site 12. As another example, touch screen display 24 may display as a home page or as a secondary page generated in response to touch screen input by a consumer a list of all prestocked goods that are presently stored in locker bank 11.

The general marketing campaign raises awareness of the prestocked good among local consumers who are not presently within a certain range of locker bank site 12. The general marketing campaign includes non-GPS-driven Internet push advertisements 750 and wish list fulfillment notifications 760.

Non-GPS-driven Internet push advertisements 750 are ads respecting prestocked goods that are pushed to computing devices operated by local consumers that have not recently reported a GPS position near the locker bank site where the goods are stored, such as smartphone 21 and desktop computer 22. The decision whether to send an Internet push advertisement, the good to be advertised and the content of the advertisement (e.g., whether to provide a special discount code) to such computing devices may be influenced by information acquired by system management processor 14 about the local consumers who operate such computing devices, such as demographic, past purchase and wish list information. Such computing devices may be configured to admit, decline, or selectively admit based on content non-GPS-driven Internet push advertisements 750. A non-GPS-driven Internet push advertisement may take various forms, such as an email alert, text alert or social media alert.

Wish list fulfillment notifications 760 are ads respecting prestocked goods that are transmitted to computing devices operated by local consumers who have specifically requested to be notified about the availability of the prestocked good. A with list fulfillment notification may take various forms, such as an email alert, text alert or social media alert.

Returning to FIG. 5, in response to the marketing campaign, an inquiry is received from a local consumer about the prestocked good (510). The inquiry may be transmitted by the computing device operated by the local consumer that received an advertisement or notification for the prestocked good. For example, smartphone 18 may transmit to system management processor 14 via the Internet 15 an inquiry responsive to a short-range network advertisement received via wireless access point 17. As another example, smartphone 18 may transmit to system management processor 14 via the Internet 15 an inquiry responsive to a GPS-driven Internet push advertisement. Alternatively, the inquiry may be made by the local consumer on touch screen display 24 of locker bank 11 after receiving an advertisement or notification for the prestocked good and walking into locker bank site 12. In that event, locker bank 11 relays the inquiry to system management processor 14 for processing.

Next, system management processor 14 determines whether the good inquired about is still available for purchase at locker bank 11 by checking the unsold inventory at locker bank 11. The good inquired about may no longer be available for purchase at locker bank 11 if, for example, it has already been bought by another local consumer. This may be particularly likely where the good inquired about is a recently released item for which there is very high demand. If the good inquired about is no longer available for purchase in locker bank 11, system management processor 14 checks the unsold inventory at other locker banks and notifies the local consumer who made the inquiry of a locker bank nearest to locker bank 11 where a good like the good inquired about (e.g., same make and model) is available for purchase (515). Alternatively, system management processor 14 may notify the local consumer of the nearest N locker banks, where N is greater than one. The nearest availability notification may be transmitted via the Internet 15 and displayed on the computing device operated by the local consumer or on touch screen display 24, depending on the source of the inquiry.

On the other hand, if the good inquired about is still available for purchase at locker bank 11, system management processor 14 recommends to the local consumer who made the inquiry an additional prestocked good available for purchase at locker bank 11 (520). System management processor 14 identifies the additional good to be recommended by cross-correlating the unsold inventory at locker bank 11 with the prestocked good that the local consumer has inquired about and information known by system management processor 14 about the local consumer, such as demographic, past purchase and wish list information. One or more additional goods may be recommended. The recommendation may be transmitted via the Internet 15 and displayed on the computing device operated by the local consumer or on touch screen display 24, depending on the source of the inquiry.

Next, a purchase commitment for the good inquired about and/or the additional good is received from the local consumer (525). The purchase commitment may be made on the computing device operated by the local consumer or on touch screen display 24.

Next, system management processor 14 processes the purchase and provides an access key for the one of lockers 23 in which the purchased good is stored (530). If multiple goods were purchased, access keys for multiple lockers where the purchased goods are stored are provided. The access key or keys are transmitted via the Internet 15 and displayed on the computing device operated by the local consumer or on touch screen display 24, depending on the source of the purchase commitment.

Next, the local consumer inputs the access key on touch screen display 24 and the access key is verified by system management processor 14 (535). The local consumer may input access key at his or her convenience, which may be immediately after receipt of the access key or at a later time. The access key is entered on touch screen display 24 and is transmitted via the Internet 15 to system management processor 14, which validates the access key against a stored access key. If multiple goods were purchased, access keys for multiple lockers where the purchased goods are stored are inputted and validated.

Finally, the one of lockers 23 containing the purchased good is unlocked (540). Once the locker has been unlocked, the local consumer opens the locker, removes the good and leaves locker bank site 12 with the good in hand. If multiple access keys were entered and verified, multiple lockers where the purchased goods are stored are unlocked.

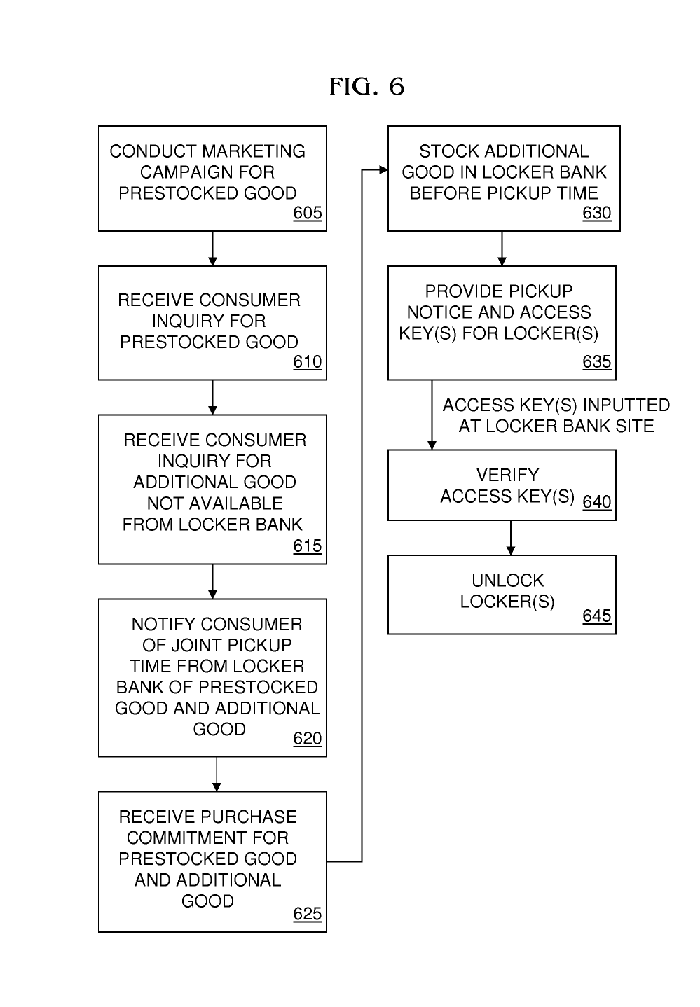

FIG. 6 shows a second method for facilitating commercial distribution of merchandise from a prestocked locker. In this method, the local consumer purchases a good that is prestocked in locker bank 11 as well as an additional good that is not prestocked in locker bank 11. System 10 notifies the local consumer of a joint pickup time at locker bank 11 for the prestocked good and the additional good and the additional good is stocked in locker bank 11 prior to the joint pickup time.

As in the first method, a marketing campaign is conducted to raise awareness among local consumers of the availability for purchase of a prestocked good from one of lockers 23 (605) and an inquiry is received from a local consumer about the prestocked good (610). However, the local consumer also inquires about an additional good that is not prestocked in locker bank 11 (615). System management processor 14 notifies the local consumer of a joint pickup time that the prestocked good and the additional good would be available for pickup at locker bank 11 if the local consumer were to purchase both goods (620). Next, a purchase commitment for both the prestocked good and the additional good is received from the local consumer (625). System management processor 14 then issues a prestocking order that is transmitted and displayed on display device 16. The prestocking order indicates to prestock the second good in locker bank 11 prior to the joint pickup time. Next, the prestocking order is fulfilled by adding the additional good to one of lockers 23, which may be the one of lockers 23 already stocked with the prestocked good or a vacant locker in locker bank 11 (630). Next, system management processor 14 provides a joint pickup notice and one or more access keys for the one or more of lockers 23 in which the prestocked good and the additional good are stored (635). Next, the local consumer inputs the one or more access keys on touch screen display 24 and the access keys are verified by system management processor 14 (640). Finally, the one or more lockers containing the purchased good and the additional good are unlocked (645). Once the lockers have been unlocked, the local consumer opens them, removes the goods and leaves locker bank site 12 with the goods in hand.

The methods of FIGS. 5 and 6 may also be performed without a marketing campaign or without the local consumer responding to a marketing campaign. For example, system management processor 14 may host a searchable web catalog of the actual inventory at locker bank 11 and the local consumer using desktop computer 22 remote from locker bank site 12 may inquire about a prestocked good at locker bank 11 after perusing the searchable web catalog or Internet website.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come within the meaning and range of equivalents thereof are intended to be embraced therein.

What is claimed is:

1. A system for promoting spontaneous purchases of goods, comprising:
a locker bank having a plurality of lockers configured to securely store a plurality of goods including purchased goods awaiting pick-up and available for purchase goods, a data input interface configured to receive inputs, and a display configured to display outputs; and
a system management processor communicatively coupled with the locker bank and configured to receive, from a network device, a Global Positioning System (GPS) position of the network device, transmit to the network device, based on detecting proximity of the network device to the locker bank using the GPS position, an advertisement for an available for purchase good securely stored in the locker bank, further configured to receive from the network device a purchase commitment for the good and activate in response to the purchase commitment a locker access key allowing an operator of the network device to unlock an individual one of the lockers securely storing the good by providing over the data input interface an input validated using the locker access key.

2. The system of claim 1, wherein the system management processor is configured to select content for the advertisement based on personal information about the operator of the network device.

3. The system of claim 2, wherein the personal information comprises demographic information about the operator of the network device.

4. The system of claim 2, wherein the personal information comprises past purchase information for the operator of the network device.

5. The system of claim 2, wherein the personal information comprises a wish list for the operator of the network device.

6. The system of claim 1, wherein the system management processor is configured select content for the advertisement based on whether the good is a clearance item.

7. The system of claim 1, wherein the network device is a mobile computing device.

8. The system of claim 1, wherein the network device is a smartphone.

9. The system of claim 1, wherein the network device is a car.

10. The system of claim 1, wherein the locker bank is configured to provide drive-through access to the operator of the network device.

11. The system of claim 1, wherein the advertisement comprises a location of the locker bank.

12. The system of claim 1, wherein the system management processor is configured to receive from the network device in response to the advertisement an inquiry about the good and transmit to the network device in response to the inquiry a location of the locker bank.

13. The system of claim 1, wherein activation of the locker access key comprises transmitting the locker access key to the network device.

14. The system of claim 1, wherein the locker access key comprises a numeric code.

15. The system of claim 1, wherein the locker access key comprises biometric information associated with the operator of the network device.

16. The system of claim 1, wherein a location of the individual locker within the locker bank is displayed as an output on the display in response to validating the locker access key.

17. The system of claim 1, wherein the data input interface comprises a touch screen.
